(19) United States
(12) Patent Application Publication
(10) Pub. No.: US 2007/0143197 A1
(43) Pub. Date: Jun. 21, 2007

(54) Systems and methods for calculating reserve capital requirements

(76) Inventors: Jackie M. Ineke, Zurich (CH); Conrad Vincent, Mumbai (IN)

Correspondence Address: KIRKPATRICK & LOCKHART PRESTON GATES ELLIS LLP, 535 SMITHFIELD STREET, PITTSBURGH, PA, 15222, US

(21) Appl. No.: 11/311,002

(22) Filed: Dec. 19, 2005

(51) Int. Cl. G06Q 40/00

(52) U.S. Cl. 705/36 R

(57) ABSTRACT

Computer assisted methods of estimating a future market value of a financial asset. The methods may comprise the steps of determining, with a computer system, a future reserve capital requirement for the financial asset under a future regulatory framework and determining a future profitability metric for the financial asset considering a present market value of the financial asset and the future reserve capital requirement. In various embodiments, the methods may also include the steps of determining, with the computer system, a present reserve capital requirement for the financial asset under a present regulatory framework and determining, with the computer system, a present return on equity for the financial asset considering the present market value and the present reserve capital requirement.

### BACKGROUND

Banks hold many different kinds of financial assets, often in substantial quantities. For example, banks may hold traditional loans, as well as other assets such as securitized loans, bonds, other debt instruments, equity instruments, derivative instruments, etc. Often banks hold a large enough volume of financial assets that their actions can drive the prices or spreads of the financial assets in the market. For example, if banks are generally selling a particular asset, its price may fall and/or its spread may widen. Conversely, if banks are generally buying a particular asset, its price may rise and/or its spread may tighten. Accordingly, knowing the desirability of particular financial assets to banks provides insight into the assets' future prices and/or spreads.

Due to banks' financial structure, the desirability of particular financial assets to banks depends not only on the assets' prices and/or spreads, but also on the cost that banks incur by holding the assets. For example, banks back many financial assets by carrying an amount of reserve capital corresponding to individual assets. Reserve capital is kept either as cash or highly liquid investments and is intended to prevent banks from becoming insolvent in the event that the assets fail. Theoretically, the amount of reserve capital kept corresponding to a particular financial asset is proportional to the economic risk that the asset will fail, e.g., the risk that a debtor will default. In practice, however, most banks only back an asset with the minimum reserve capital requirement, as set forth in the regulatory framework of the jurisdiction or jurisdictions in which the banks operate. Accordingly, the minimum reserve capital requirements as well as the prices or spreads of financial assets factor into the desirability of the assets to banks.

In recent years, new and increasingly complex regulatory frameworks governing minimum reserve capital requirements have been introduced and are in the process of being implemented. For example, the “International Convergence of Capital Measurement and Capital Standards: A Revised Framework” (Basel II) was finalized in June of 2004 and will be implemented in various jurisdictions from 1 Jan. 2007 onwards. The complexity of the new Basel II regulatory framework, as well as the differences between Basel II and existing frameworks such as, for example, the 1988 Basel Accord (Basel I), make it increasingly difficult to predict the minimum reserve capital requirements for particular financial assets and therefore predict future prices and/or spreads of the assets.

### SUMMARY

According to one general aspect, the present invention is directed to computer assisted methods of estimating a future market value of a financial asset. The methods may comprise the steps of determining, with a computer system, a future reserve capital requirement for the financial asset under a future regulatory framework and determining, with the computer system, a future profitability metric for the asset considering a present market value of the financial asset and the future reserve capital requirement. In various embodiments, the methods may also comprise the steps of determining, with the computer system, a present reserve capital requirement for the financial asset under a present regulatory framework and determining, with the computer system, a present return on equity for the financial asset considering the present market value and the present reserve capital requirement.

According to various implementations, Basel II may be the future regulatory framework and Basel I may be the present regulatory framework. The methods may also comprise the step of determining, with the computer system, a break-even market value for the asset, where a present return on equity of the financial asset considering the Basel I reserve capital requirement and a present market value of the financial asset is about equal to a future return on equity considering the Basel II reserve capital requirement and the break-even market value of the financial asset.

According to other general aspects, the present invention is directed to computer assisted methods for determining the direction of change between a present market value of a financial asset and a future market value of the financial asset. The methods may comprise the steps of determining, with a computer system, a reserve capital requirement for the financial asset and determining, with the computer system, a profitability metric for the financial asset considering the reserve capital requirement and the present market value of the asset. The methods may also comprise the step of comparing the profitability metric for the financial asset with a baseline profitability metric for the financial asset with the computer system.

According to yet other aspects of the present invention, computer assisted methods for designing a financial asset are disclosed. The methods may comprise the steps of determining, with a computer system, a reserve capital requirement for a first iteration of the financial asset and determining, with the computer system, a profitability metric for the first iteration of the financial asset considering the reserve capital requirement and the present market value of the asset. The methods may also comprise the step of developing, with the computer system, a second iteration of the financial asset based on the reserve capital requirement and the profitability metric.

In another general aspect, the present invention is directed to a system for estimating a future market value of a financial asset. The system may comprise a future reserve capital module that determines a future reserve capital requirement for the financial asset under a future regulatory framework and a profitability metric module that determines a future profitability metric for the asset considering a present market value of the financial asset and the future reserve capital requirement. In various embodiments, the system may also comprise a present reserve capital module that determines a present reserve capital requirement for the financial asset under a present regulatory framework. The profitability metric module may also determine a present return on equity for the financial asset considering the present market value and the present reserve capital requirement.

### BRIEF DESCRIPTION OF THE FIGURES

FIG. 1 is a flowchart of a process flow according to various embodiments of the present invention;

FIG. 2 is a block diagram of a computer system according to various embodiments of the present invention;

FIGS. 3A and 3B are flowcharts of process flows according to other embodiments of the present invention;

FIG. 4 is a block diagram of a computer system according to other embodiments of the present invention; and

FIGS. 5A-5B, 6A-6C, 7A-7B, 8, 9A-9C, 10A-10B, 11A-11B, 12A-12C, and 13-16 show screen shots of user interfaces according to various embodiments of the present invention.

### DESCRIPTION

Various embodiments of the present invention may be employed to find and/or estimate various properties of financial assets based on reserve capital requirements. As used herein, the term “financial asset” refers to any non-physical item of economic value. Examples of financial assets include loans, securitized loans, derivatives including, for example, collateralized debt obligations (CDO), first to default baskets, any other securities, for example, as defined by the Securities Act of 1933, etc. Other examples of financial assets include loan assets, receivables, etc. As used herein, the term “market value” refers to a measure of the value of a financial asset. Exemplary market values may include prices, spreads to a reference interest rate, etc.

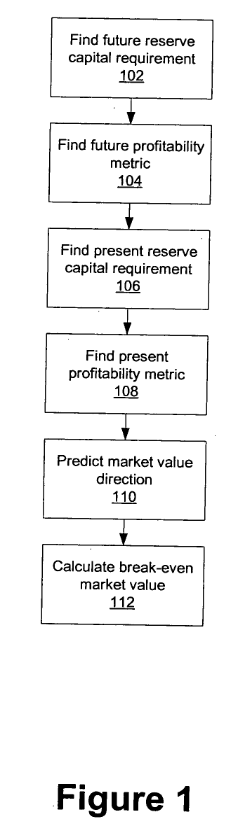

FIG. 1 shows a flowchart illustrating a process flow 100 for estimating the future market value (e.g., price and/or spread) of a financial asset by comparing the minimum reserve capital that banks and other financial institutions subject to minimum reserve capital requirements (collectively referred to as “banks” for simplicity) are required to hold against the financial asset under a future regulatory framework and a present regulatory framework according to various embodiments of the present invention. Changes in the minimum reserve capital requirement for the financial asset between the present and future regulatory schemes may make the asset more or less desirable to banks. As banks buy and/or sell the financial asset in response to the change in the asset's desirability, the market value of the asset may change. Predicting the change in desirability of the asset between the present and future regulatory scheme may provide insight into the future market value of the asset.

According to the embodiment shown in FIG. 1, a future reserve capital requirement (e.g., the minimum reserve capital to be held against the financial asset under a future regulatory framework) is found at step 102. The future regulatory framework may be any proposed regulatory framework governing reserve capital requirements that is known, but not yet implemented. For example, Basel II has been proposed, but has not yet been implemented. Accordingly, until it is implemented Basel II may be the future regulatory framework. It is envisioned that the future regulatory framework could also be a successor to Basel II, or some other regulatory framework. It will be appreciated that the present and/or future regulatory frameworks may be actual implementations of the Basel I and/or Basel II requirements by various jurisdictions. For example, the actual implementation of Basel II in European Union (EU) is by the Capital Requirements Directive.

A future profitability metric for the financial asset under the future regulatory framework is then found at step 104 considering the future reserve capital requirement and the present price and/or spread of the asset. The profitability metric may be any measurement indicating the value of the financial asset to a bank. The profitability metric may, for example, consider the market value of the asset as well as the reserve capital requirement applying to the asset. Exemplary profitability metrics may include the cost of funding a purchase of the asset (e.g., the cost of raising Tier 1, Tier 2 and senior debt to finance the purchase), the Return on Capital (RoC), etc. In one non-limiting embodiment, the profitability metric may be the Return on Equity (“ROE”) of the financial asset. The ROE may be found, for example, according to Equation 1 below:

$$ROE ∝ \frac{asset\_return - financing\_cst - predicted\_loss}{reserve\_capital} \qquad ( 1 )$$

where “reserve_capital” connotes the reserve capital requirement, “asset_return” connotes the return that the bank receives on the asset, “financing_cst” connotes the cost of financing the purchase of the asset, and “predicted_loss” connotes the loss that the bank expects on the asset. For a high quality asset with negligible expected loss, ROE may be approximated according to Equation 2 shown below:

$$ROE ∝ \frac{excess\_spread}{reserve\_capital} \qquad ( 2 )$$

where “excess_spread” connotes the spread of the asset considering its funding costs. It will be appreciated that changes in reserve capital requirements, for example, between the future regulatory framework and the present regulatory framework, may cause significant changes in the ROE and other profitability metrics associated with a financial asset.

At step 106, the minimum reserve capital requirement for the financial asset may be found under a present regulatory framework. The present regulatory framework may be the regulatory framework presently in place in a relevant jurisdiction. For example, for banks whose minimum capital requirements are currently determined under the Basel I framework, Basel I could be used as the present regulatory framework. At step 108, a present profitability metric may be found for the financial asset using the minimum reserve capital requirement for the financial asset under the present regulatory framework and the present price and/or spread of the financial asset and the funding cost of that asset, for example, according to Equations 1 and/or 2.

At step 110, a prediction of the future direction of the market value of the financial asset as the future regulatory framework is implemented may be determined. The prediction may be determined by comparing the future profitability metric with the present profitability metric. It will be appreciated that if the future profitability metric is greater than the present profitability metric, then the financial asset may become more attractive to banks. Accordingly, banks may buy the asset as the implementation of the future regulatory framework approaches, creating a pressure in the market pushing the market value of the asset up (e.g., the price of the asset may be pushed up and/or the spread of the asset may tighten). Conversely, if the future profitability metric is lower than the present profitability metric, then the financial asset will become unattractive to banks, causing them to sell the asset as the implementation of the future regulatory framework approaches. Accordingly, the market value of the asset may then drop.

At step 112, a break-even market value for the financial asset may be found. The break-even market value may be the market value where the future profitability metric for the asset is equal to the present profitability metric at the market value of the asset prior to the implementation of the future regulatory framework, for example, as shown in Equation 3 below:
(break_even_market_return-financing_cost-expected_loss)/future_reserve_capital=(current_market_return-financing costs-expected loss)/present_reserve_capital (3)
where “present_reserve_capital” is the reserve capital requirement under the present regulatory scheme and “future_reserve_capital” is the reserve capital requirement under the future regulatory scheme. When the financial asset reaches the break-even market value, then there may no longer be any reserve capital-induced incentive for banks to buy or sell the asset, stabilizing the asset's market value. Accordingly, the break-even market value may be a reasonable estimate of the market value of the financial asset after the implementation of the future regulatory framework.

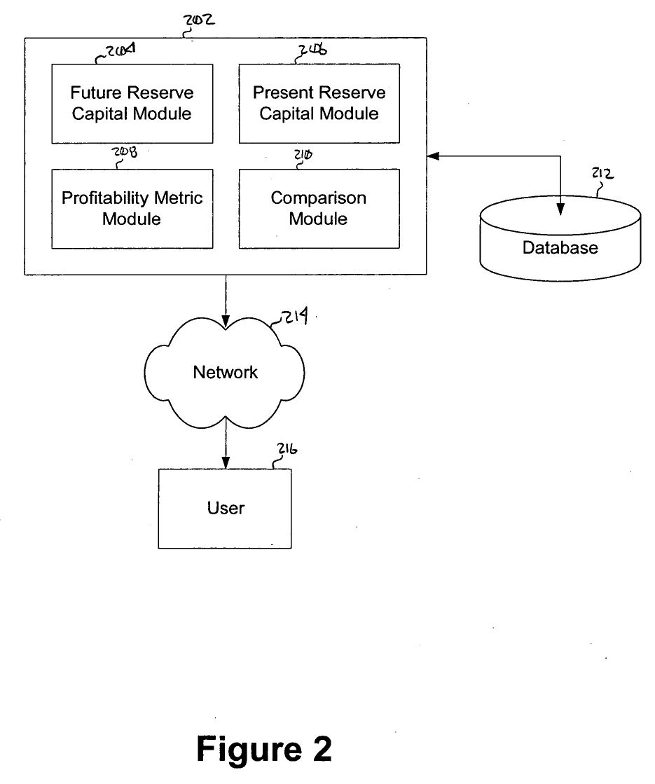

FIG. 2 shows a system 200 that may be used to implement the process flow 100 of FIG. 1 according to various embodiments of the present invention. The system 200 may include a computer system 202 that may be in communication with a user 216, for example, over a communications network 214, such as a LAN, a WAN, the Internet, etc. The user 216 may be, for example, a financial product engineer, a manager of a bank's treasury book or the manager of a bank's proprietary trading/asset management book, and/or another interested party, such as a reserve capital-insensitive asset manager who simply wishes to understand where banks may drive market values under the new regulatory scheme. The user 216 may receive information relating to reserve capital from the computer system 202. For example, the user 216 may be provided with the future reserve capital requirement of the asset, the present reserve capital requirement of the asset, an estimate of the future direction of the financial asset's price and/or spread, a break-even price and/or spread, etc. The computer system 202 may utilize a database 212 to retrieve and store data necessary to perform the steps of the process flow 100. For example, the database 212 may contain details regarding the present and/or future regulatory framework (e.g., data representing a set of equations and/or constant values necessary to find regulatory requirements under the regulatory frameworks), the price and/or spread of one or more financial assets, etc.

The computer system 202 may include one or a number of networked computer devices and may include one or a number of modules including, for example, as shown in FIG. 2, a future reserve capital module 204, a present reserve capital module 206, a profitability metric module 208, and a comparison module 210. In various embodiments, the future reserve capital module 204 may calculate the future reserve capital requirement for the financial asset based on the future regulatory framework (see step 102 of FIG. 1). The present reserve capital module 106 may calculate the present reserve capital requirement based on the present regulatory framework (see step 106 of FIG. 1). The profitability metric module 208 may determine the future profitability metric and/or a present profitability metric of the financial asset (see steps 104 and 108 of FIG. 1). Also, the comparison module 210 may compare the profitability metrics to find a predicted direction of the asset's price and/or spread (see step 110 of FIG. 1) or a break-even price and/or spread (see step 112 of FIG. 1), as described above.

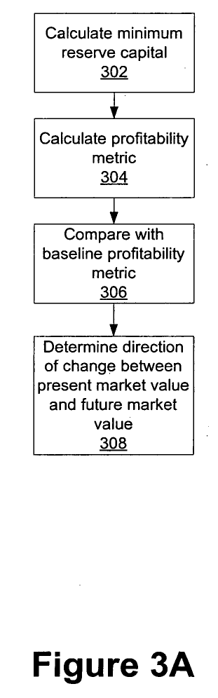

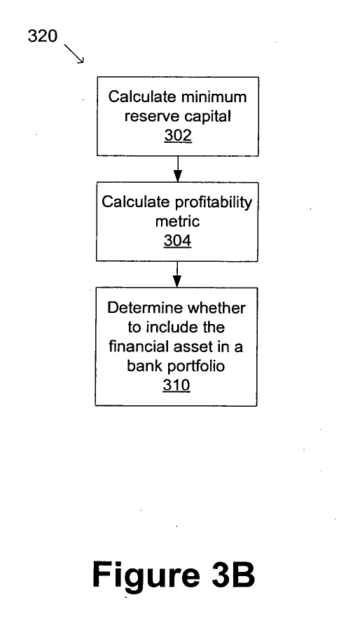

FIG. 3A shows a flowchart illustrating a process flow 300 according to various embodiments of the present invention for estimating the future price and/or spread of a financial asset where regulatory reserve capital requirements are static. For example, the process flow 300 of FIG. 3A could be used to estimate the future price/spread of a financial asset once Basel II is implemented. At step 302, a reserve capital requirement for the financial asset may be found for the static regulatory framework of interest. The regulatory framework for this step may be, for example, the current framework that is in place. At step 304, a profitability metric for the financial asset may be found given its present market value and the reserve capital requirement. The profitability metric may be the ROE or any other suitable profitability metric.

At step 306, the present profitability metric may be compared to a baseline profitability metric. The baseline profitability metric may be the expected profitability metric for the financial asset. For example, the baseline profitability metric may be an average of profitability metrics for the financial asset over a given amount of time, for example, a year. In various embodiments, the baseline profitability metric may also be found by considering the cost to banks of holding equity. For example, the baseline profitability metric may be the level where most banks make a modest profit on the underlying asset given their cost of equity. The baseline profitability metric may also be, for example, a minimum profitability metric at which a bank may hold the financial asset at a profit, or the current profitability metric, taking into account current reserve capital requirements, the funding costs of the bank, and the market value of a particular asset. It may be expected that the present probability metric of the financial asset will return to the baseline profitability metric in the future. At step 308, a future direction of the market value of the financial asset may be predicted based on the present profitability metric and the baseline profitability metric. For example, if the present profitability metric is above the baseline profitability metric, then the market value of the financial asset may be expected to fall. Conversely, if the present profitability metric is below the baseline profitability metric, then the market value of the financial asset may be expected to rise.

FIG. 3B shows a flowchart illustrating a process flow 320 for determining whether to include a financial asset in the portfolio of a bank. Steps 302 and 304 may be the same as in the process flow 300 of FIG. 3A. At step 310, it may be determined whether to include the financial asset in the portfolio of a bank based on, for example, the profitability metric. If the profitability metric indicates that the asset will be profitable to the bank, it may be determined that the bank should hold the asset. If the profitability metric indicates that the asset will not be profitable to the bank, it may be determined that the bank should not hold the asset.

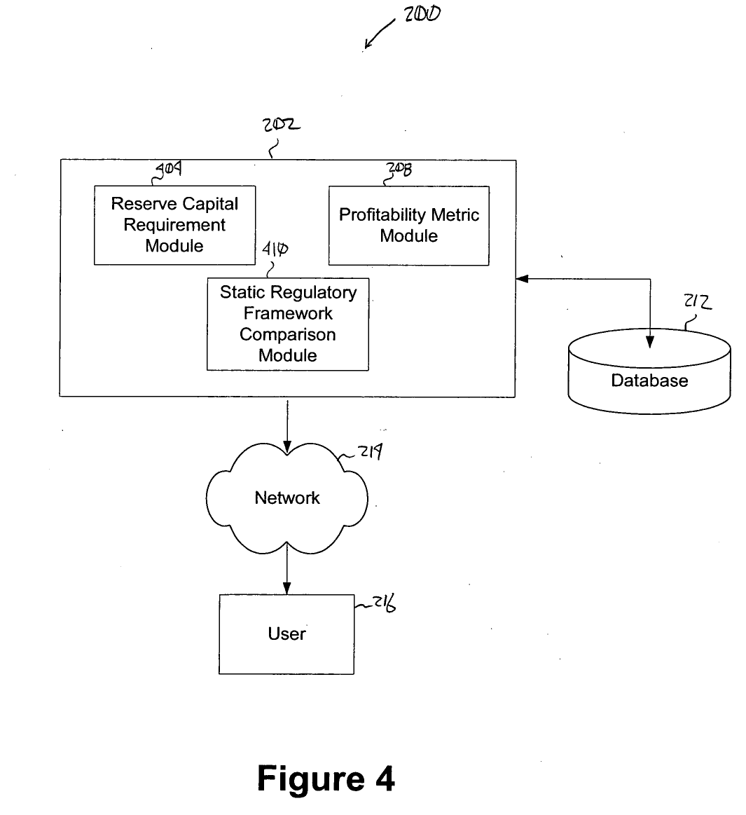

FIG. 4 shows an embodiment of the system 200 that may be used to implement the process flows 300 and/or 320 of FIGS. 3A and 3B according to various embodiments of the present invention. As shown in FIG. 4, the computer system 202 may include a reserve capital requirement module 404, a profitability metric module 208 and a static regulatory framework comparison module 410. In various embodiments, the reserve capital requirement module 404 may calculate a reserve requirement for the financial asset under the regulatory framework of interest. The profitability metric module 208 may calculate a profitability metric for the financial asset (e.g., an ROE as shown in Equations 1 and 2). In various embodiments, the static regulatory framework comparison module 410 may calculate an expected direction of the price and/or spread of the financial asset, for example, by comparing a profitability metric for the financial asset with a baseline profitability metric as described above.

If the user 216 is an analyst the user 216 may use price and/or spread trends to forecast the market value of the financial asset. The analyst may also use break-even prices and/or spreads, for example, those determined according to process flow 100, to predict a future market value of the financial asset. If the user 216 is an engineer of financial products, the user 216 may consider present and future reserve capital requirements as well as profitability metrics in the process of designing a new financial asset. For example, such a user 216 may use these and other measurements to tailor the properties of the new financial asset, for example, to make the new financial asset more or less desirable to banks. Such a user 216 may, for example, develop a first iteration of the financial asset and use the system 200 to find the reserve capital requirement and profitability metric for the first iteration. If these values are not acceptable, then a subsequent iteration of the financial asset may be developed, at least in part by the components of the system 200. If the user 216 manages capital for a bank, the user 216 may use present as well as future regulatory reserve capital requirements and profitability metrics to determine which assets his or her bank should hold.

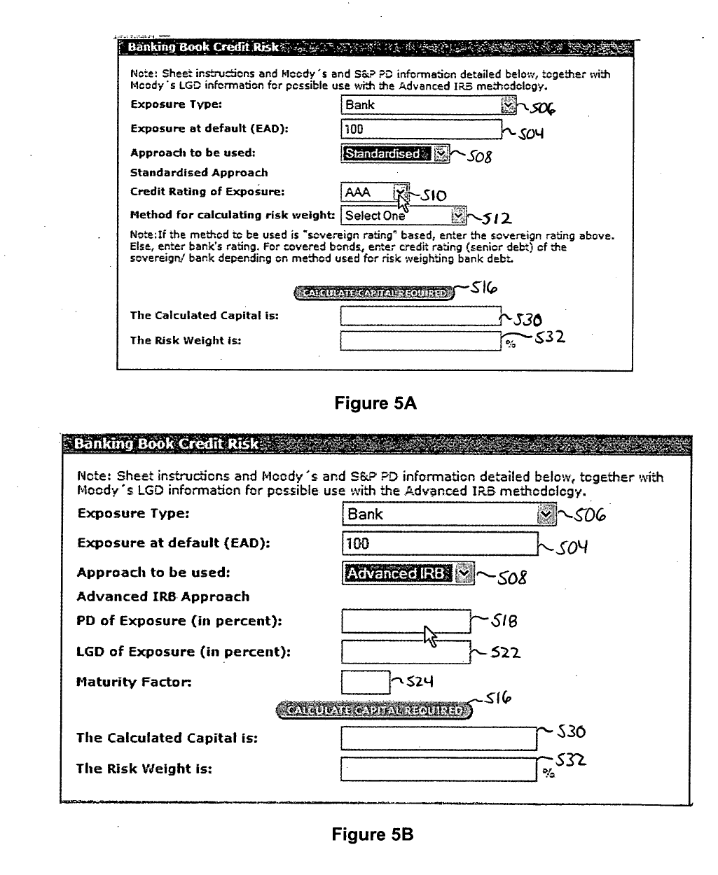

FIGS. 5A-5C, 6A-6C, 7A-7B, 8, 9A-9C, 10A-10B, and 11A-11B show screen shots of a user interface that the computer system 202 may serve to a user 216, via the communications network 214, to allow the user 216 to find a minimum reserve capital requirement under the Basel II regulatory framework according to various embodiments. In this non-limiting example embodiment, Basel II is the future regulatory framework and Basel I is the present regulatory framework. The user interface shown in FIGS. 5A-5C, 6A-6C, 7A-7B, 8, 9A-9C, 10A-10B, and 11A-11B may allow the user 216 to perform all or a portion of the process of FIGS. 1, 3A and/or 3B.

It will be appreciated that the Basel II regulatory framework treats different classes of financial assets and/or risk generating events differently. Accordingly, the screen shots shown in FIGS. 5A-5C, 6A-6C, 7A-7B, 8, 9A-9C, 10A-10B, and 11A-11B may each deal with a different class of financial assets. FIGS. 5A-5B show screen shots of a user interface 500 for allowing the user 216 to calculate reserve capital requirements for a financial asset under Basel II. The embodiment shown in user interface 500 allows reserve capital requirements to be found using three methods allowed under Basel II, the Standardised Approach, the Foundation Internal Ratings Based (IRB) Approach and the Advanced IRB Approach. The method to be used may be selected in box 508. For example, FIG. 5A shows the interface 500 configured according to the Standardised Approach, while FIG. 5B shows the interface 500 configured according to the Foundation or Advanced IRB Approach.

According to the Standardised Approach, and the Foundation and Advanced IRB Approach, the exposure at default (EAD) of the financial asset may be entered in box 504. The EAD may represent the bank's total exposure in the event that the asset goes into partial or complete default. The type of exposure may be entered at box 506. The type of exposure may denote the type of entity whose debt and/or equity the financial asset represents. Non-limiting examples of exposure types may include, for example, Bank, Corporate-Large, Corporate-Small and Small to Medium Sized Enterprise (SME), Retail-Mortgages, Retail-Qualifying Revolving, Retail-Other, Covered Bond, and/or Equity.

According to the Standardised Approach shown in FIG. 5A, the credit rating of the financial asset may be entered at box 510. The credit ratings may be those provided by any suitable ratings provider including, for example, MOODY'S, S&P, and/or FITCH. Credit ratings according to various embodiments may range from AAA for the highest rated assets to D for assets in default. Unrated and other may also be entered in box 510 where appropriate. In various embodiments, an asset may be “unrated” if no agency has given it a rating. Likewise, an asset may be classified as “other” if its rating is not available at box 510. The method for calculating the risk weight may be entered in box 512. Methods for calculating the risk weight for bank and covered bond exposures may include sovereign rating and credit assessment. After all information necessary to calculate reserve requirements under the Standardised Approach is entered, button 516 may be activated, causing the reserve capital required for the financial asset to be determined and displayed a field 530. In various embodiments, the risk-weighted exposure for the financial asset may also be determined and displayed at field 532.

When the Foundation IRB Approach is selected at box 508, the reserve capital requirements for the financial asset may be calculated according to that method as shown in FIG. 5B. Boxes 504 and 506 may be filled out as described above with respect to the Standardised Approach. The probability of exposure (PD) may be entered in box 518. The PD may be the percentage risk that the financial asset will fail. The Basel II regulatory framework may allow banks to calculate PD based on their own internal estimates. Button 516 may then be selected to determine the reserve capital requirement and/or the risk weighted exposure of the bank at fields 530 and 532

If the Advanced IRB Approach is used, it may be selected at box 508. Boxes 504, 506 and 518 may be selected as above. In addition, according to the Advanced IRB Approach, Loss Given Default (LGD) of the exposure may be entered in box 522 and the Maturity Factor may be entered in box 524. LGD may be the amount of the Exposure at Default (EAD) that will not be recovered by the bank in the event of default. The maturity factor may be a number that reflects the term or maturity of the financial asset. For example, a financial asset with a longer maturity may have a higher risk of default. The button 516 may then be selected as described above, displaying the output reserve capital requirements and/or the risk weighted exposure of the bank at fields 530 and 532.

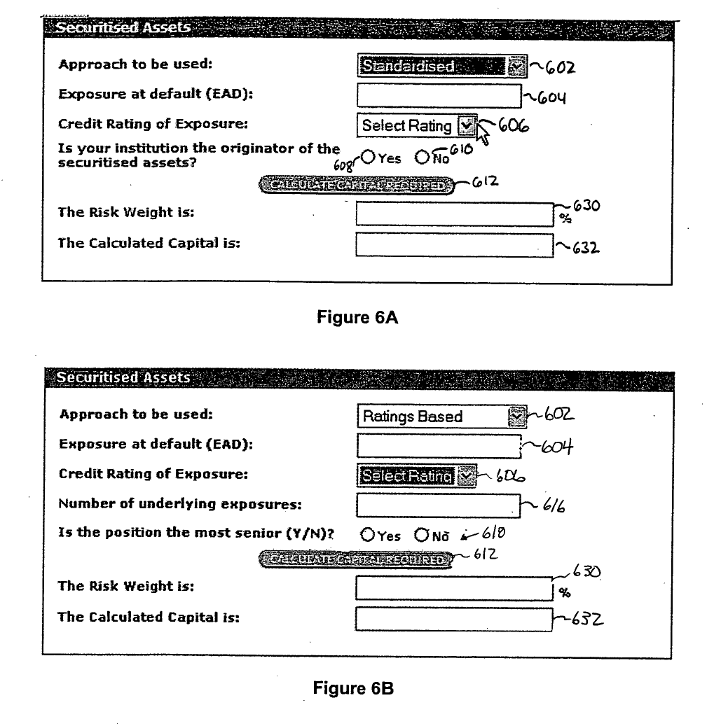

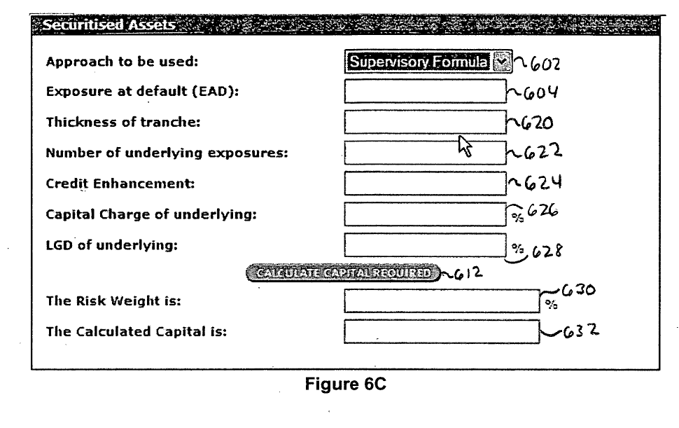

FIGS. 6A, 6B and 6C show screen shots illustrating an embodiment of a user interface 600 allowing the user 216 to calculate reserve capital requirements for a financial asset under Basel II for Securitized Assets. The approach to be used may be entered at box 602. Acceptable approaches under Basel II may include the Standardised approach, the Ratings Based approach, and the Supervisory Formula Approach. For example, FIG. 6A shows the interface 600 configured according to the Standardised Approach, FIG. 6B shows the interface 600 configured according to the Ratings Based Approach and FIG. 6C shows the interface 600 configured according to the Supervisory Formula Approach. For all approaches, the EAD may be entered at box 604.

Referring to FIG. 6A, if the Standardised Approach is selected, then the credit rating of the securitized asset may be entered at box 606. Box 608 or 610 may be selected depending on whether the bank is the originator of the securitized asset. Button 612 may then be activated, causing the reserve capital requirement and/or the risk weighted exposure of the financial asset to be calculated and displayed, for example at boxes 630 and 632. Referring to FIG. 6B, if the Ratings Based Approach is selected, the credit rating of the asset may be entered at box 606. The number of underlying exposures may be entered at field 616. Whether the financial asset is the most senior in the securitized group may be entered at box 618. Again, the reserve capital requirement and/or the risk weighted exposure of the financial asset may be found by activating button 612 and displayed at boxes 630 and 632.

Referring to FIG. 6C, the Supervisory Formula may be used to find reserve capital requirements for securitized financial. The thickness of the tranche including the securitized asset may be entered at box 620. The number of underlying exposures may be entered at box 622. A credit enhancement may be entered at box 624. The credit enhancement may reflect subordination of the tranche or cash collateral/guarantee posted to reduce tranche credit risk. A capital charge of the underlying asset may be entered in box 626 and an LGD of the underlying at box 628. The reserve capital requirement and/or the risk weighted exposure of the financial asset may be found by activating button 612 and may be displayed at fields 630 and 632.

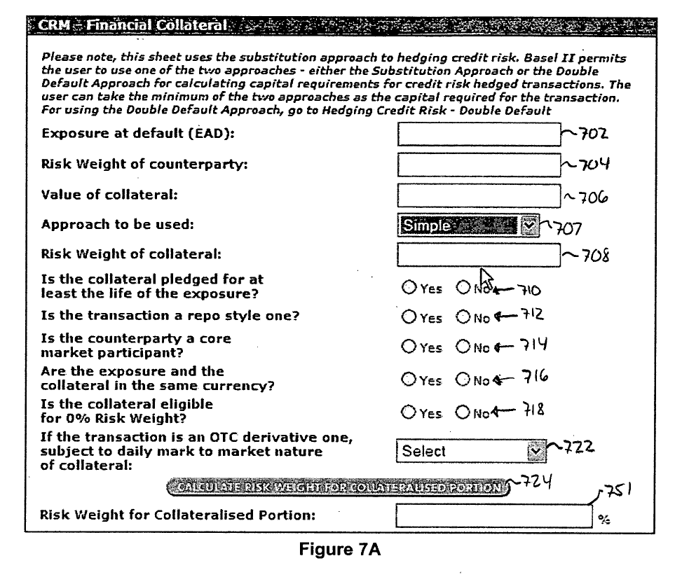

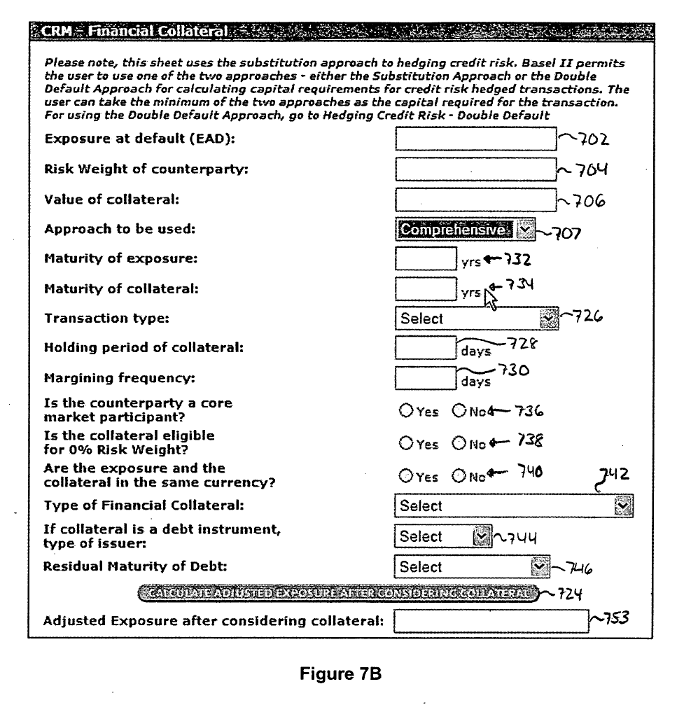

FIGS. 7A and 7B show a screen shot illustrating an embodiment of a user interface 700 for allowing the user 216 to find the Credit Risk Mitigation (CRM) associated with financial collateral. The results found through interface 700 may be used to supplement reserve capital requirement information calculated using screen shots 500 and 600, for example by facilitating calculation of the impact of collateral on risk weight. Basel II provides approaches for finding CRM for financial collateral including the Simple Approach and the Comprehensive Approach. The user 216 may select an approach, for example, from drop-down menu 707. For both approaches, the EAD for the financial asset, Risk Weight of the counterparty and value of the collateral may be entered at boxes 702, 704 and 706 respectively.

FIG. 7A shows the interface 700 configured according to the Simple Approach. The Risk Weight of the collateral may be entered at box 708. Whether the collateral is pledged for at least the life of the exposure may be indicated at field 710. Whether the collateral transaction is repossession style may be indicated at field 712. Boxes 714 and 716 may indicate whether the counterparty is a core market participant and whether the exposure and collateral are in the same currency, respectively. If the collateral is eligible for 0% risk weight, then field 718 may be filled in as indicated in interface 700. If the transaction is an OTC derivative, then the mark to market nature of the collateral may be entered at box 722. For example, the mark to market nature of the collateral may be cash or 0% risk weight securities. The Risk Weight for the collateralized portion of the financial asset may then be found and displayed at box 751 when button 724 is selected.

FIG. 7B shows the interface 700 configured according to the Comprehensive Approach according to various embodiments. Under the Comprehensive approach, an Adjusted Exposure may be calculated. The Adjusted Exposure may be used later to calculate the Adjusted LGD. Boxes 702, 704 and 706 may be filled in as described above. The transaction type may be entered into box 726. The holding period of the collateral in days may be entered in box 728. The margining frequency may be entered in box 730 and the maturity of the exposure and maturity of the collateral may be entered into boxes 732 and 734 respectively. If the counterparty is a core market participant, then that may be indicated at box 736. Whether the collateral is eligible for 0% risk weight may be indicated at box 738, and whether the exposure and the collateral are of same currency may be indicated at box 740. The type of financial collateral may be entered at box 742. Exemplary types of financial collateral may include debt of various ratings, main index equities, gold, other listed equities, cash, etc. If the collateral type is debt, then the type of issuer may be indicated at box 744, and may be, for example, sovereign or other. The residual maturity of the debt may be entered at box 746. The Adjusted Exposure may then be calculated and displayed at box 753 by selecting button 724.

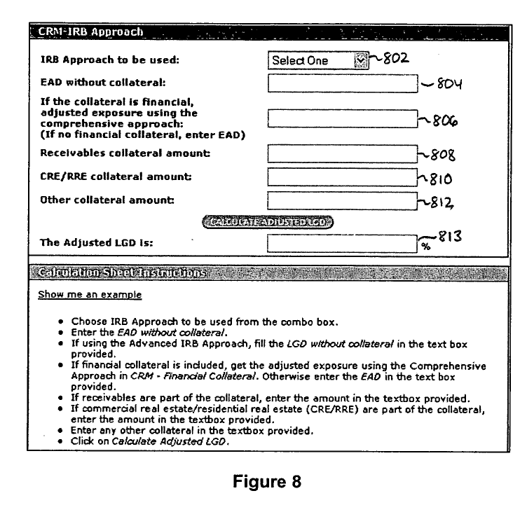

FIG. 8 shows a screen shot illustrating an embodiment of a user interface 800 for allowing the user 216 to find an Adjusted LGD given collateral. The Adjusted LGD may then be used, for example, in one or more of the embodiments of screen shots 500 and/or 600 in an IRB Approach to find a reserve capital requirement given the collateral. At box 802, the type of IRB Approach to be used may be selected. For example, the Foundation IRB Approach or the Advanced IRB Approach may be used. At box 804, the EAD without collateral may be entered, if the Advanced IRB Approach is used. At box 806, the adjusted exposure using the Comprehensive Approach may be entered. This may, for example, have been calculated as illustrated by screen shot 700. If the collateral includes receivables, the receivables collateral amount may be entered at box 808. If the collateral includes commercial real estate (CRE) or residential real estate (RRE), then the appropriate amount may be entered into box 810. Any other collateral amount may be entered into box 812. The Adjusted LGD may be calculated and displayed at box 813 when button 814 is selected.

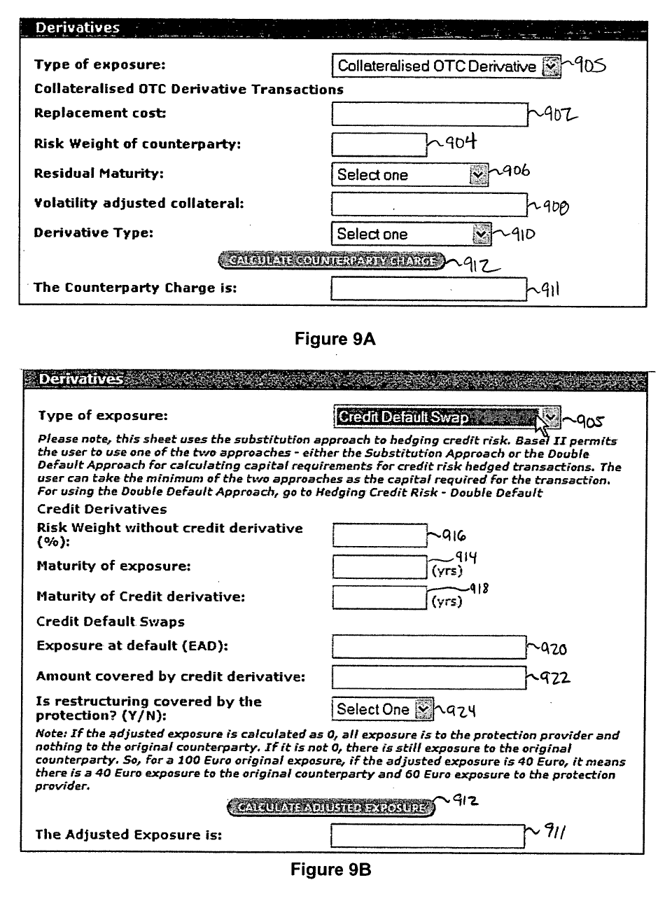

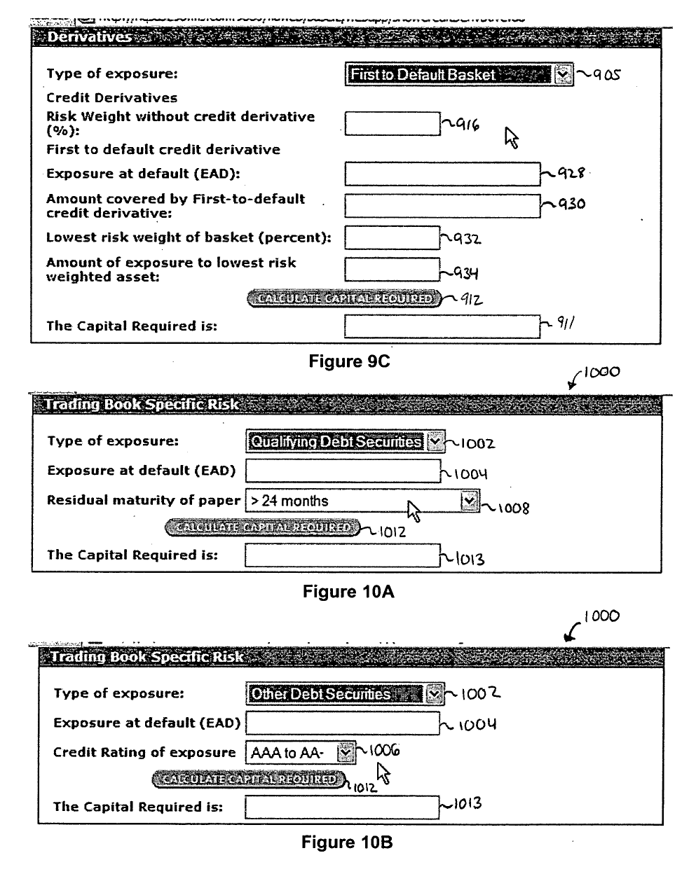

FIGS. 9A, 9B and 9C shows a screen shots illustrating an embodiment of a user interface 900 for allowing the user 216 to find reserve capital requirements for a financial asset that is a derivative. The type of exposure may be entered at field 905. If the financial asset is a Collateralized Over the Counter (OTC) derivative, then the interface 900 may be configured as shown in FIG. 9A. At box 902, the replacement cost of the derivative exposure may be entered. This may be the marked to market value of the exposure. At box 904, the risk weight of the counter party may be entered. This value may be calculated, for example, as shown in screen shot 500. The residual maturity of the derivative exposure may be selected at box 906. The amount of volatility adjusted collateral may be entered at box 908. This value may, for example, be calculated as shown in screen shot 700. The derivative type may be entered in box 910. Exemplary derivative types may include interest rate, exchange rate/gold, equity, precious metals, other commodities, etc. The counterparty charge may be calculated when button 912 is selected.

For credit derivatives, the interface 900 may be configured as shown in FIG. 9B. At box 916, the risk weight without credit derivative may be entered. This value, for example, may be calculated as shown in screen shot 500. The maturity of the derivative exposure and maturity of credit derivative may be entered at boxes 914 and 918 respectively. If the derivative is a credit default derivative, then the EAD may be entered at 920. The amount covered by the credit derivative may be entered at box 922, and whether restructuring is covered by the protection may be indicated at box 924. The Adjusted Exposure may be calculated and displayed at box 911 when button 912 is selected. If the derivative is a first to default derivative, then the interface 900 may be configured as shown in FIG. 9C. For example, the EAD may be entered at box 928 and the amount covered by the derivative may be entered at box 930. If the derivative covers a basket of risks, then the lowest risk weight of the basket may be entered at box 932 and the amount of disclosure to the lowest risk weighted asset may be entered at box 934. The reserve capital requirement for the financial asset may be calculated and displayed at box 911 when button 912 is selected.

FIGS. 10A and 10B show screen shots of an embodiment of a user interface 1000 for allowing the user 216 to find capital requirements for trading book assets according to various embodiments. Trading book assets may include assets that the bank does not intend to hold to maturity, but instead intends to sell on the market in an attempt to make a profit. Examples of trading book assets may include, for example, stocks, bonds, derivatives, etc. The embodiment shown in FIG. 10 is a screen shot 1000 for determining the reserve capital requirement under Basel II for debt securities held in a bank's trading book. The type of the exposure may be selected in field 1002. Exemplary exposure types include, Government Paper, Qualifying Debt Securities and Other Debt Securities. For example, FIG. 10A shows the interface 1000 configured for qualifying debt securities and FIG. 10B shows the interface 1000 configured for other debt securities. For either, the EAD of the financial asset may be entered at field 1004. If the security is an other debt security, then the credit rating of the exposure may be entered at box 1006 shown in FIG. 10B. If the security is a qualifying debt security, then the residual maturity of the paper may be entered at box 1008 shown in FIG. 10A. The capital required for the asset may be calculated and displayed at box 1013 by selecting button 1012.

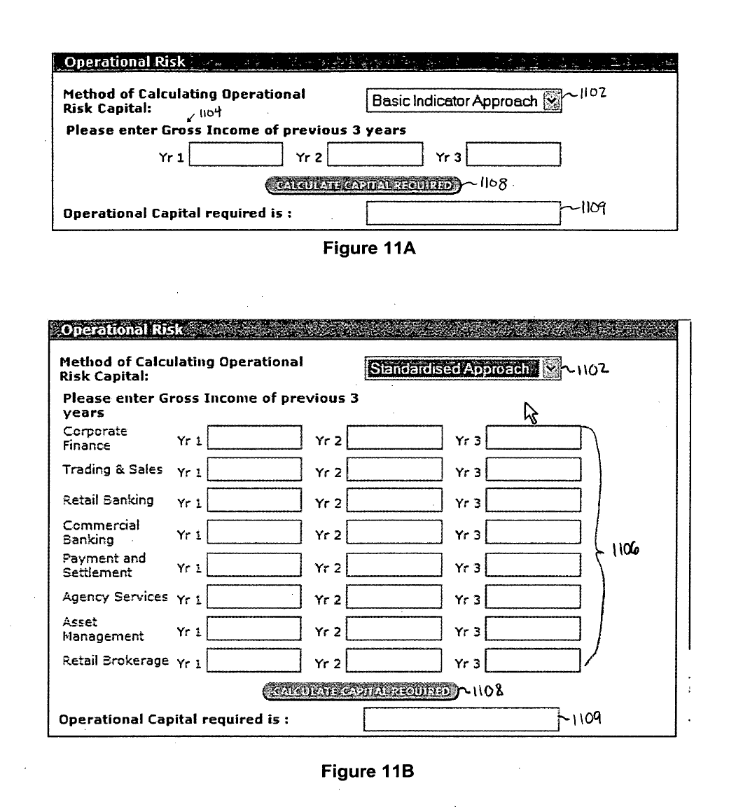

FIGS. 11A-11B show screen shots of an embodiment of a user interface 1100 for allowing the user 216 to find reserve capital requirements stemming from operational risk according to various embodiments. Operational risk may be risk of loss from inadequate or failed internal processes, people and systems or from external events. Whilst operational risk charges may not to impact market valuations of assets, it is included in various embodiments of the model for completeness. Specifically, for the manager of a bank's capital, operational risk may be included to calculate the reserve capital requirements of the entire bank's business.

Referring to FIGS. 11A and 11B, the approach for calculating operational risk capital may be selected at box 1102. Example methods of calculating operational risk capital under Basel II may include the Basic Indicator Approach and the Standardized Approach. FIG. 11A shows the interface 1100 configured according to the Basic Indicator Approach. The bank's gross income of the previous three years may be entered in row 1104. The button 1108 may then be selected, calculating the reserve capital required to back the bank's operational risk and displaying it at box 1109. FIG. 11B shows the interface 1100 configured according to the Standardised Approach. The bank's gross income over the past three years may be broken down into the categories listed in rows 1106 and then entered into the appropriate boxes within the rows 1106. Categories may include corporate finance, trading & sales, retail banking, commercial banking, payment and settlement, agency services, asset management, and retail brokerage. Selecting the button 1108 may then cause the reserve capital requirement for the bank's operation risk under the Standardised Approach to be found and displayed at box 1109.

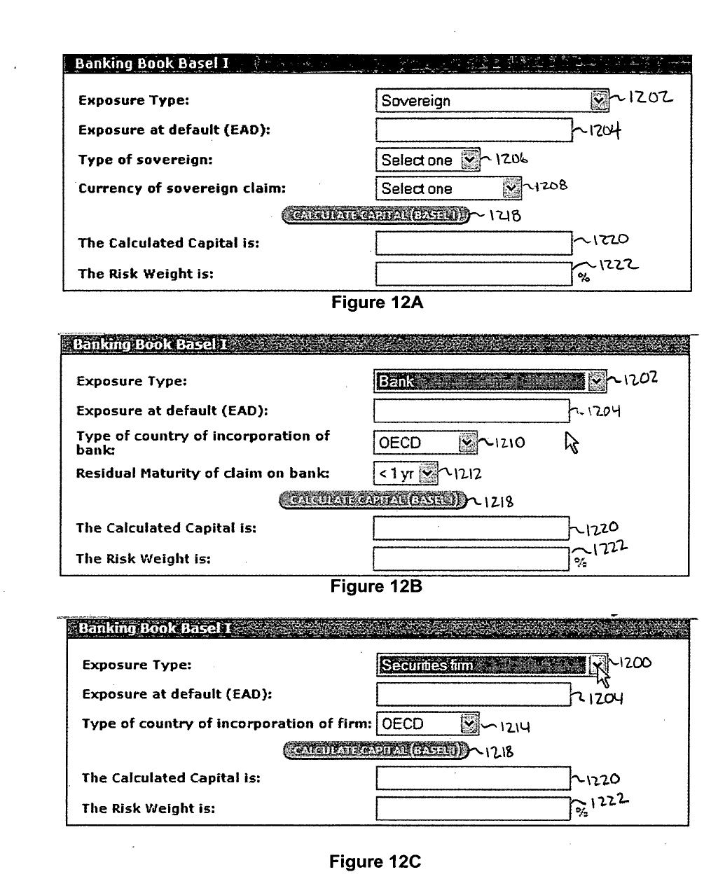

FIGS. 12A, 12B and 12C show screenshots of a user interface 1200 that the computer system 202 may serve to the user 216 to allow the user 216 to find a minimum reserve capital requirement under the Basel I regulatory framework according to various embodiments. The user interface 1200 may allow the user 216 to perform all or a portion of the process of FIGS. 1, 3A and/or 3B. For example, when the present regulatory framework is the Basel I framework, the user interface 1200 may allow the user 216 to find a future minimum reserve capital requirement for a financial asset.

In the embodiment shown in interface 1200, the exposure type may be entered at box 1202. Exemplary exposure types may include bank capital, residential mortgage, securities firm, corporate/retail, bank, multilateral development bank, sovereign, etc. For all exposure types, the EAD, may be entered at box 1204. FIG. 12A shows the interface 1200 configured for when the exposure is to a sovereign. The type of sovereign may be entered at box 1206. According to various embodiments, sovereigns may be members of the Organization Economic Cooperation and Development (OECD), or non-members (non-OECD). The currency of the sovereign exposure may be entered at box 1208. For example, whether the exposure is in the national currency of the sovereign or in a foreign currency may be indicated. FIG. 12B shows the interface 1200 configured for when the exposure is to a bank. The OECD status of the bank's country of incorporation may be indicated in box 1210 along with the residual maturity of the claim on the bank at box 1212. FIG. 12C shows the interface 1200 configured for when the exposure is to a securities firm. The OECD status of the country of incorporation of the securities firm may be indicated at box 1214. The reserve capital requirements for the financial asset under Basel I may be displayed when button 1218 is selected. For FIGS. 12A-12C, the calculated capital and risk weight of the exposure may be displayed at boxes 1220 and 1222 respectively when button 1218 is selected.

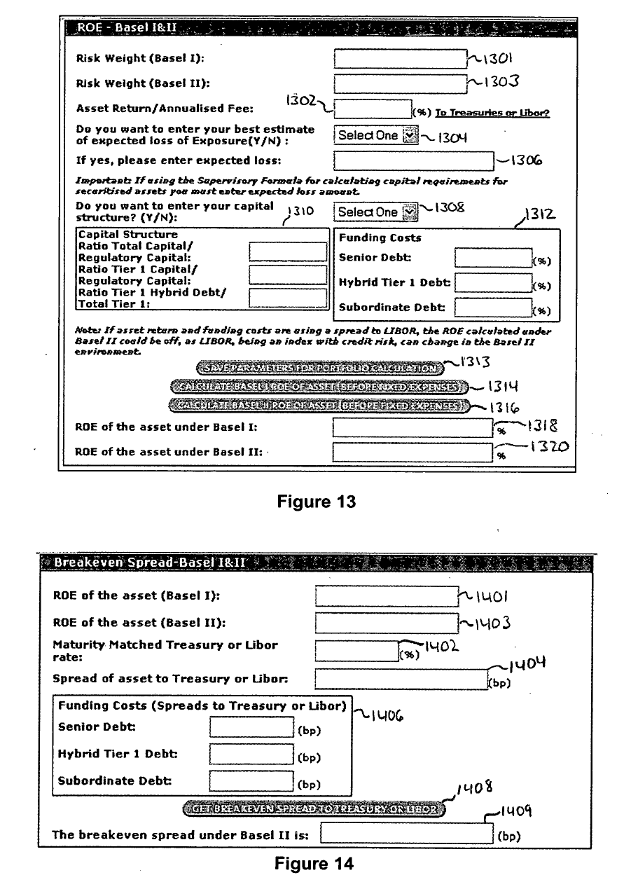

FIG. 13 shows a screenshot of an implementation of a user interface 1300 that the computer system 202 may serve to the user 216 to allow the user 216 to calculate the profitability metric of a financial asset to a bank. The user interface 1300 may allow the user 216 to perform all or a portion of the process of FIGS. 1, 3A and/or 3B. For example, the user interface 1300 may allow the user 216 to find a future and/or present profitability metric for a financial asset. Referring to the interface 1300, the risk weight of the asset according to Basel I and Basel II may be entered at boxes 1301 and 1303 respectively. The risk weights for the asset may be been calculated utilizing other interfaces as discussed above. In one non-limiting embodiment, boxes 1301 and 1303 may be pre-populated with risk weights calculated using the other interfaces.

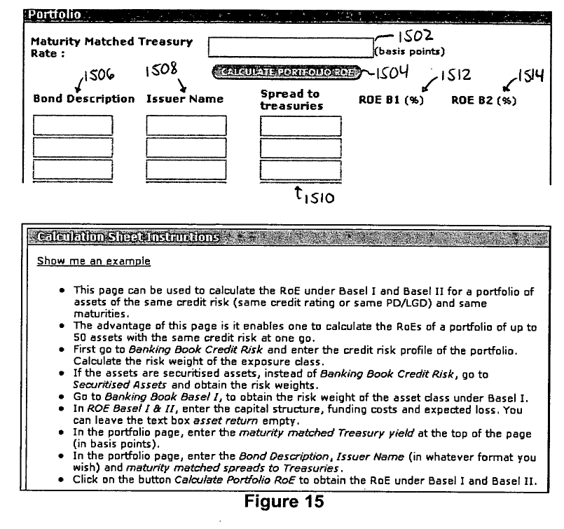

The user 216 may enter the asset return/annualized fee at box 1302. This value may represent the price and/or spread of the asset. The expected loss may be indicated and entered at boxes 1304 and 1306. If capital structure information is to be provided, it may be indicated at box 1308 and provided in box 1310. Funding costs for capital may be provided at box 1312. The ROE of the financial asset under the future regulatory framework may be calculated and displayed at box 1320 when button 1314 is selected. The ROE of the financial asset under the present regulatory framework may be found and displayed at box 1318 when button 1316 is selected. Selecting button 1313 may save the parameters entered at interface 1300 for use in a portfolio calculation, for example, as described below with reference to FIG. 15.

In screenshot 1300, the future regulatory framework is listed as Basel II and the present regulatory framework is listed as Basel I. It will be appreciated, however, that the future regulatory framework may be any framework that has been proposed, but not yet implemented, in a jurisdiction and the present regulatory framework may be any framework implemented in a jurisdiction. It will be appreciated that certain values necessary for calculating ROE may not be shown in screenshot 1300, but may be residual values calculated in other screens. For example, the reserve capital requirements under Basel I and Basel II may have been calculated in one or more of screens shown in FIGS. 5-12.

FIG. 14 shows a screenshot of a user interface 1400 for allowing the user 216 to calculate the break-even market value for a financial asset. The user interface 1400 may allow the user to perform all or a portion of the methods shown in FIGS. 1, 3A and 3B. Referring to the screenshot 1400, the ROE of the asset under Basel I and Basel II may be entered at boxes 1401 and 1403 respectively. The ROE may be calculated using the interface 1300 as described above. In one non-limiting embodiment, boxes 1401 and 1403 may be pre-populated based on the results of FIG. 13. The Maturity matched Treasury or Libor rate may be entered at box 1402. The spread of the asset to the Treasury or Libor rate may be entered at box 1404. Funding costs may be entered at field 1406. The break-even spread may be calculated and displayed at field 1409 when button 1408 is depressed.

FIG. 15 shows a screenshot of a user interface 1500 for allowing the user to calculate the ROE for multiple assets simultaneously, for example, according to multiple regulatory schemes. In various embodiments, all of the assets may have the same credit risk, e.g., the same credit rating or same PD/LGD. Referring to the interface 1500, the Maturity Matched Treasury Rate may be entered at box 1502. Information about the assets may be entered in columns 1506, 1508 and 1510. For example, a description of each asset may be entered in column 1506. The name of the issuer of each asset may be entered at column 1508, and the spread of each asset to the Treasury Rate may be entered at column 1510. Other information about the assets may be calculated based on data entered in other interfaces including, for example, interface 1300 as saved by selecting button 1313. Selecting button 1504 of the interface 1500 may cause the ROE of each asset to be calculated. ROE's under Basel I may be shown in column 1512 and ROE's under Basel II may be shown at column 1514.

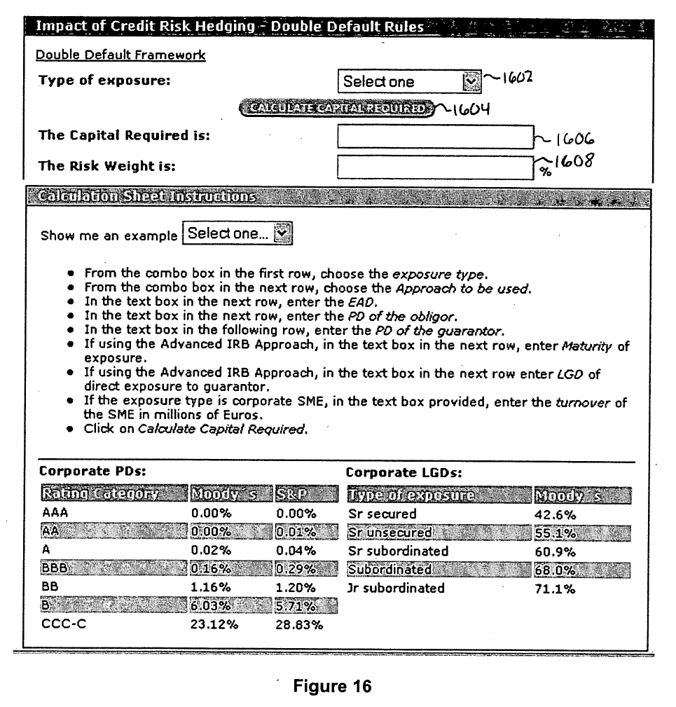

FIG. 16 shows a screen shot of a user interface 1600 for determining the impact of credit risk hedging under double default rules. This screen may allow the user 216 to calculate capital requirements for transactions that are guaranteed by another entity. The type of exposure may be selected from menu 1602. Other boxes (not shown) may provide input locations for the approach to be used, the EAD, the PD of the obligor, the PD of the guarantor. If the Advanced IRB Approach is used, additional boxes (not shown) may include input locations for the maturity of the exposure and the LGD of the direct explosure to the guarantor. If the exposure type is corporate SME, then the turnover of the SME in millions of Euros may be listed in another box (not shown). Clicking on the button 1604 may cause the capital required and the risk weight to be shown at boxes 1606 and 1608 respectively.

It is to be understood that the figures and descriptions of the present invention have been simplified to illustrate elements that are relevant for a clear understanding of the present invention, while eliminating, for purposes of clarity, other elements, such as, for example, details of inputs and outputs for user interface screens 500, 600, 700, 800, 900, 1000, 1100, 1200, 1300, 1400, etc. Those of ordinary skill in the art will recognize that these and other elements may be desirable. It will be appreciated, for example, that any of the input fields described above may be any kind of input field including, drop-down menus, text entry fields, etc. However, because such elements are well known in the art and because they do not facilitate a better understanding of the present invention, a discussion of such elements is not provided herein.

As used herein, a “computer” or “computer system” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for processing data for standalone application and/or over a networked medium or media. Computers and computer systems disclosed herein may include operatively associated memory for storing certain software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, ROM (read only memory), RAM (random access memory), PROM (programmable ROM), EEPROM (extended erasable PROM), and/or other like computer-readable media.

The various modules 204, 206, 208, 210, 404, 408, 410 of the computer system 202 may be implemented as software code to be executed by a processor(s) of the computer system 202 or any other computer system using any type of suitable computer instruction type. The software code may be stored as a series of instructions or commands on a computer readable medium.

The term “computer-readable medium” as used herein may include, for example, magnetic and optical memory devices such as diskettes, compact discs of both read-only and writeable varieties, optical disk drives, and hard disk drives. A computer-readable medium may also include memory storage that can be physical, virtual, permanent, temporary, semi-permanent and/or semi-temporary. A computer-readable medium may further include one or more data signals transmitted on one or more carrier waves.

While several embodiments of the invention have been described, it should be apparent that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention as defined by the appended claims.

We claim:

1. A computer assisted method of estimating a future market value of a financial asset, the method comprising:
determining, with a computer system, a future reserve capital requirement for the financial asset under a future regulatory framework; and
determining, with the computer system, a future profitability metric for the financial asset considering a present market value of the financial asset and the future reserve capital requirement.

2. The method of claim 1, further comprising:
determining, with the computer system, a present reserve capital requirement for the financial asset under a present regulatory framework; and
determining, with the computer system, a present profitability metric for the financial asset considering the present market value and the present reserve capital requirement.

3. The method of claim 2, wherein the present regulatory framework is the Basel I framework.

4. The method of claim 2, further comprising determining a predicted direction of change between the present market value and a future market value of the financial asset.

5. The method of claim 2, further comprising determining a break-even market value of the financial asset.

6. The method of claim 2, further comprising determining a predicted future market value of the financial asset.

7. The method of claim 6, wherein determining a predicted future market value of the financial asset includes considering the present profitability metric and the future reserve capital requirement.

8. The method of claim 1, wherein the financial asset is selected from the group consisting of a fixed income security, a securitized asset, a derivative and a collateral-backed asset.

9. The method of claim 1, wherein the market value of the financial asset includes at least one of the group consisting of a spread to a reference interest rate and a price.

10. The method of claim 1, wherein the future profitability metric includes a Return on Equity (ROE).

11. The method of claim 1, wherein the future regulatory framework is the Basel II framework.

12. The method of claim 1, wherein the future regulatory framework is a successor to the Basel II framework.

13. A computer assisted method of estimating a future market value of a financial asset, the method comprising:
determining, with a computer system, a Basel II reserve capital requirement for the financial asset under the Basel II regulatory framework;
determining, with the computer system, a Basel I reserve capital requirement for an asset under the Basel I regulatory framework; and
determining, with the computer system, a break-even market value for the financial asset, where a present return on equity of the financial asset considering the Basel I reserve capital requirement and a present market value of the financial asset is about equal to a future return on equity considering the Basel II reserve capital requirement and the break-even market value of the financial asset.

14. The method of claim 13, wherein the financial asset is a fixed-income security and at least the present market value includes a spread to a reference interest rate.

15. The method of claim 13, wherein the financial asset is selected from the group consisting of a fixed income security, a securitized asset, a derivative and a collateral-backed asset.

16. A computer assisted method for determining the direction of change between a present market value of a financial asset and a future market value of the financial asset, the method comprising:
determining, with a computer system, a reserve capital requirement for the financial asset;
determining, with the computer system, a profitability metric for the financial asset considering the reserve capital requirement and the present market value of the financial asset; and
comparing the profitability metric for the financial asset with a baseline profitability metric for the financial asset, with the computer system.

17. The method of claim 16, further comprising determining the direction of change between the present market value of the financial asset and the future market value of the financial asset based on whether the profitability metric from the financial asset is higher than the baseline profitability metric for the financial asset.

18. The method of claim 16, wherein the profitability metric includes a return on equity (ROE).

19. The method of claim 16, wherein the market value of the financial asset includes at least one of a price and a spread to a reference interest rate.

20. The method of claim 16, wherein the baseline profitability metric includes a historical average of profitability metrics for the financial asset.

21. The method of claim 16, wherein the baseline profitability metric is an estimation of the minimum profitability metric of the financial asset at which a bank can hold the financial asset and make a profit.

22. A computer assisted method for designing a financial asset, the method comprising:
determining, with a computer system, a reserve capital requirement for a first iteration of the financial asset;
determining, with the computer system, a profitability metric for the first iteration of the financial asset considering the reserve capital requirement and the present market value of the financial asset; and
developing, at least in part with the computer system, a second iteration of the financial asset based on the reserve capital requirement and the profitability metric.

23. A system for estimating a future market value of a financial asset, the system comprising:
a future reserve capital module configured to determine a future reserve capital requirement for the financial asset under a future regulatory framework; and
a profitability metric module configured to determine a future profitability metric for the financial asset considering a present market value of the financial asset and the future reserve capital requirement.

24. The system of claim 23, further comprising:
a present reserve capital module configured to determine a present reserve capital requirement for the financial asset under a present regulatory framework; and
wherein the profitability metric module is also configured to determine a present return on equity for the financial asset considering the present market value and the present reserve capital requirement.

25. A computer-assisted method for estimating a future market value of a financial asset, the method comprising:
receiving an indicator of a financial asset from a user over a network;
determining a future reserve capital requirement for the financial asset under a future regulatory framework;
determining a future profitability metric for the financial asset considering a present market value of the financial asset and the future reserve capital requirement.

26. The method of claim 25, further comprising sending the future profitability metric for the financial asset to the user over the network.

27. The method of claim 25, wherein the future regulatory framework is the Basel II framework.
